(19) United States
(12) Patent Application Publication
(10) Pub. No.: US 2020/0032911 A1
(43) Pub. Date: Jan. 30, 2020

(54) Metal Face Seal With Exclusion System

(71) Applicant: Caterpillar Inc., Deerfield, IL (US)

(72) Inventor: John Michael Mashak, Peoria, IL (US)

(73) Assignee: Caterpillar Inc., Deerfield, IL (US)

(21) Appl. No.: 16/046,117

(22) Filed: Jul. 26, 2018

(51) Int. Cl. F16J 15/34

(52) U.S. Cl. CPC F16J 15/344

(57) ABSTRACT

A face seal assembly includes a first face seal member having a first upper radial surface defining an upper radial slot with a sealing surface and a second face seal member having a second upper radial surface. A sealing member extends from the second upper radial surface and contacts the sealing surface.

### TECHNICAL FIELD

The present disclosure relates to a face seal assembly that prevents the loss of lubrication from a rotating joint used in equipment such as earth moving, construction and mining equipment and the like. Specifically, the present disclosure relates to face seal assemblies that allow one component to rotate relative to another component while keeping a fluid tight seal between the components.

### BACKGROUND

Earth moving, construction and mining equipment and the like work are often used in rough, off-road terrain. These machines often employ an endless track with track shoes that is better able to propel the machines in such environments over obstacles and uneven terrain, etc. The track chains, which include shoes, are held together by a series of interconnected track links, pins and bushings that are supported on the drive sprocket, idler and support rollers of the machine. As can be imagined, lubrication is necessary to ease the movement of a track roller as the track chain passes over it, allowing the shaft on which the track roller rotates to be fixed while the roller itself rotates. A face seal assembly is often disposed at this interface between the track roller and the shaft, sealing the lubrication inside the rotating joint while allowing the roller to rotate on the shaft.

Similarly, such equipment may use power trains including a gearbox that is connected to a drive shaft or a wheel axle to power movement to a wheel. The shaft and axle are configured to rotate relative to a housing positioned near them that remains fixed. It is necessary to the ease the movement of the shaft or the axle relative to the housing or other fixed member by providing lubrication in the vicinity of the interface of the shaft or axle and the fixed member. A face seal assembly is often disposed at this interface between the housing or other fixed member and the rotating shaft or rotating axle.

Over time, the face seal assembly experiences wear. Various factors influence wear and there are various types of wear. For example, radial wear and/or asymmetric wear may occur. Causes of wear include contamination that may cause damage to the main sealing surfaces. Either type of wear, radial wear or asymmetric wear, will eventually cause the face seal to no longer effectively seal the desired lubricant in the lubricating cavity formed by the rotating component and the fixed component. This can cause downtime for the machine and presents a cost to the end user or manufacturer who then needs to replace the face seal assembly.

Accordingly, it is desirable to develop a face seal assembly that is less prone to wear out.

### SUMMARY

A face seal assembly according to an embodiment of the present disclosure comprises a first face seal member including a first cylindrical annular body defining a first cylindrical axis, a first radial direction, a first axial extremity, a second axial extremity, a first outside radial extremity and a first inside radial extremity. A first lower radial surface may extend radially from the first inside radial extremity and a first axial transitional surface may extend axially from the first lower radial surface. A first upper radial surface may extending radially from the first axial transitional surface to the first outside radial extremity. The first upper radial surface may be spaced axially away from the first lower radial surface a first predetermined distance, defining the first axial extremity. A second face seal member may include a second cylindrical annular body defining a second cylindrical axis, a second radial direction, a third axial extremity, a fourth axial extremity, a second outside radial extremity and a second inside radial extremity. A second lower radial surface may extend radially from the second inside radial extremity and a second axial transitional surface may extend axially from the second lower radial surface. A second upper radial surface may extend radially from the second axial transitional surface to the second outside radial extremity. The second upper radial surface may be spaced axially away from the second lower radial surface a second predetermined surface. The second lower radial surface may define the third axial extremity.

A face seal assembly according to another embodiment may comprise a first face seal member including a first cylindrical annular body defining a first cylindrical axis, a first radial direction, a first axial extremity, a second axial extremity, a first outside radial extremity and a first inside radial extremity. A first upper radial surface may extend radially from the first outside radial extremity. The first upper radial surface may define an upper radial slot disposed radially adjacent the first outside radial extremity. The upper radial slot may be at least partially defined by a sealing surface. A second face seal member may include a second cylindrical annular body defining a second cylindrical axis, a second radial direction, a third axial extremity, a fourth axial extremity, a second outside radial extremity and a second inside radial extremity. A second upper radial surface may extend radially from the second outside radial extremity. A sealing member may extend from the second upper radial surface and contact the sealing surface.

A face seal assembly according to yet another embodiment may comprise a first face seal member including a first cylindrical annular body defining a first cylindrical axis, a first radial direction, a first axial extremity, a second axial extremity, a first outside radial extremity and a first inside radial extremity. A first upper radial surface may extend radially from the first outside radial extremity. The first upper radial surface may define an upper radial slot disposed radially adjacent the first outside radial extremity, the upper radial slot being at least partially defined by a sealing surface. The first upper radial surface may further define a lower radial slot disposed radially below the upper radial slot, being in communication therewith and terminating at a depth positioned axially past the sealing surface. The first upper radial surface may further define a ledge disposed radially below the sealing surface. A second face seal member may include a second cylindrical annular body defining a second cylindrical axis, a second radial direction, a third axial extremity, a fourth axial extremity, a second outside radial extremity and a second inside radial extremity. A second upper radial surface may extending radially from the second outside radial extremity. A sealing member may extend axially and radially from the second upper radial surface and contact the sealing surface.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a perspective sectional view of a track roller assembly such as those used on track driven vehicles that may employ a face seal assembly according to an embodiment of the present disclosure.

FIG. 2 is a perspective sectional view of a powertrain assembly such as those used on track driven vehicles that may employ a face seal assembly according to an embodiment of the present disclosure.

FIG. 3 is a sectional view of a face seal assembly that may be used in FIGS. 1 and 2.

FIG. 4 is an enlarged sectional view of the face seal assembly of FIG. 3, looking at the face seal assembly in the top or “12 O'clock” position.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

Various embodiments of an apparatus such as a rotating joint that may use various embodiments of a face seal assembly of the present disclosure will now be discussed. Then, a face seal assembly, face seal members, and a flexible sealing member according to various embodiments of the present disclosure will be discussed in greater detail.

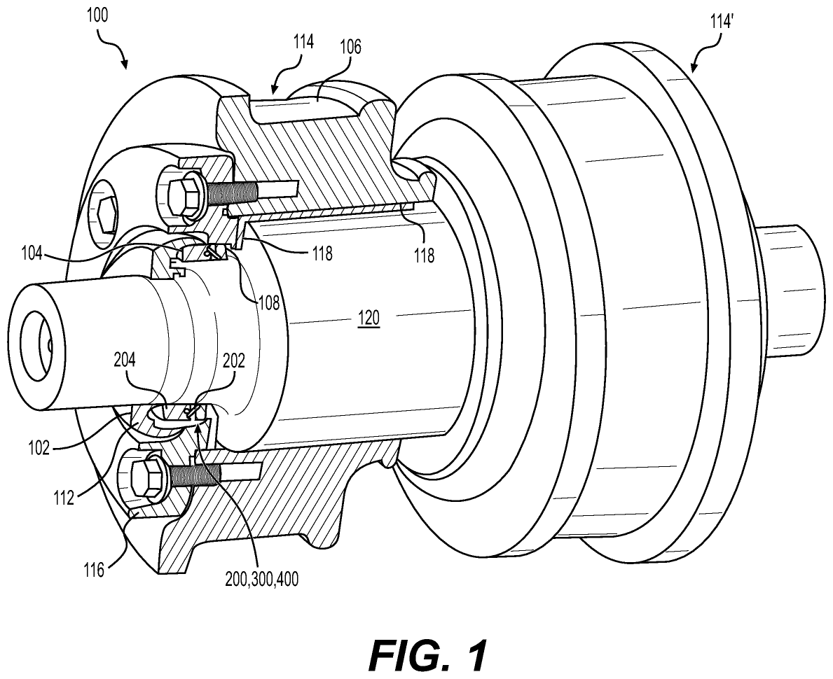

Looking at FIG. 1 a rotating joint 100 for a track roller 102 is disclosed. The rotating joint 100 comprises a stationary member 102 defining a first seal retaining cavity 104, and a rotatable member 106 defining a second seal retaining cavity 108. A face seal assembly 200, 300, 400 is disposed in the first seal retaining cavity 104 and in the second seal retaining cavity 108. The first face seal member 202 is disposed in the second seal retaining cavity 108 and the second face seal member 204 is disposed in the first seal retaining cavity 104. The second face seal member 204 may be attached to a rotating member (e.g. a track roller assembly 114) to rot ate therewith in some embodiments rather than a stationary member, helping to expel debris away from the face seal assembly. First and second load rings 110 are also shown (e.g. torics) that may be some sort of spring or elastomeric material, biasing the first face seal member 202 and the second face seal member 204 into contact with each other.

For the particular embodiment shown in FIG. 1, the stationary member 102 is an end cap 112 that defines the first seal retaining cavity 104 and the rotatable member is a track roller assembly 114 to which a cap member 116 is attached, defining the second seal retaining cavity 108. Bushing members 118 are also shown that reduce friction as the track roller assembly 114 rotates about the shaft 120 that is also stationary. One track roller assembly is shown having two symmetric sides 114, 114′.

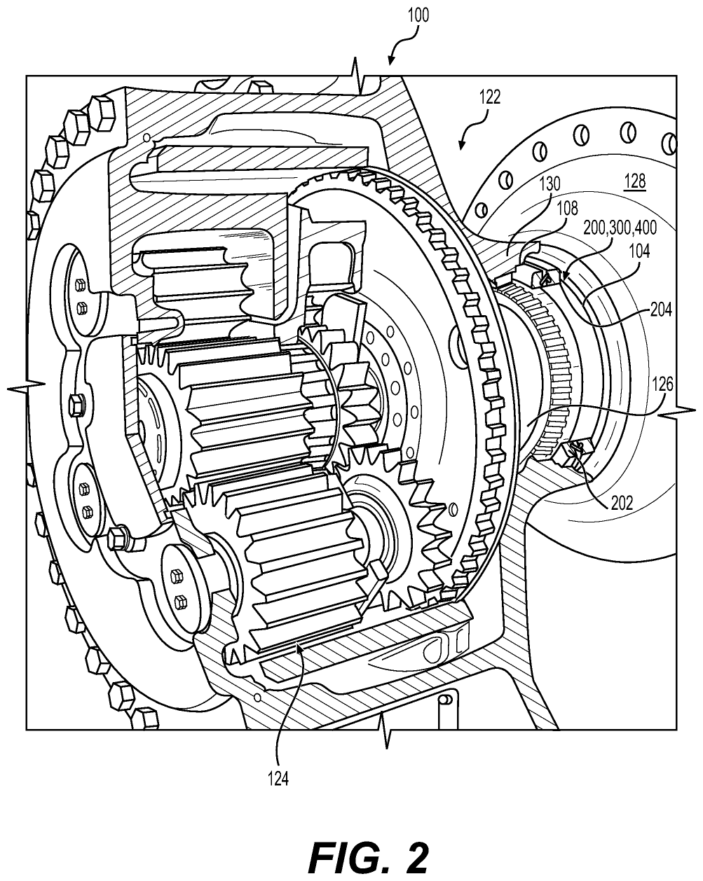

FIG. 2 shows a rotating joint 100 in the form of a powertrain final drive 122 that includes a wheel gearbox 124 about which a wheel or tire may be attached. A rotatable shaft 126 extends from a stationary housing 128 that defines the first seal retaining cavity 104 and a rotatable housing 130 that contains the wheel gearbox 124 and that defines and will rotate with the second seal retaining cavity 108.

Other types of apparatus and rotating joints other than those specifically shown in the figures or discussed in the present specification may use various embodiments of the face seal assembly, face seal member, and a flexible sealing member that will now be discussed with more particularity.

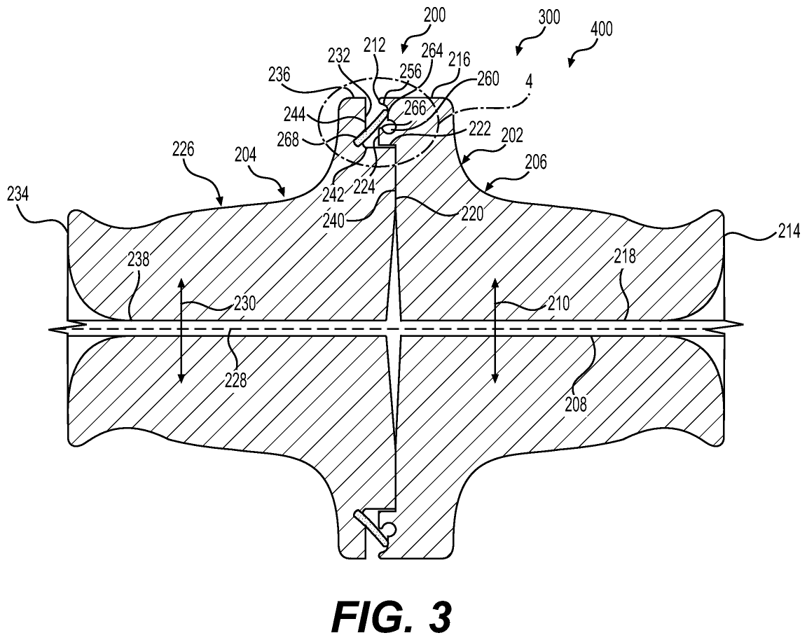

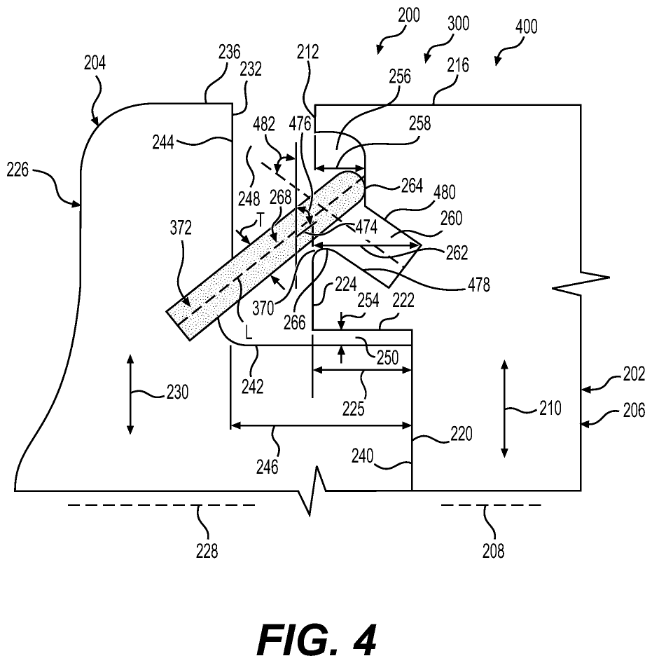

A face seal assembly 200 according to an embodiment of the present disclosure will now be described with reference to FIGS. 3 and 4. The face seal assembly 200 may comprise a first face seal member 202 including a first cylindrical annular body 206 defining a first cylindrical axis 208, a first radial direction 210, a first axial extremity 212, a second axial extremity 214, a first outside radial extremity 216 and a first inside radial extremity 218. The first face seal member 202 may further include a first lower radial surface 220 extending radially from the first inside radial extremity 218 and a first axial transitional surface 222 extending axially from the first lower radial surface 220. The first face seal member 202 may further include a first upper radial surface 224 extending radially from the first axial transitional surface 222 to the first outside radial extremity 216. The first upper radial surface 224 is spaced axially away from the first lower radial surface 220 a first predetermined distance 225, defining the first axial extremity 212.

Similarly, the face seal assembly 200 may further comprise a second face seal member 204 including a second cylindrical annular body 226 defining a second cylindrical axis 228, a second radial direction 230, a third axial extremity 232, a fourth axial extremity 234, a second outside radial extremity 236 and a second inside radial extremity 238. The second face seal member 204 further including a second lower radial surface 240 extending radially from the second inside radial extremity 238 and a second axial transitional surface 242 extending axially from the second lower radial surface 240, and a second upper radial surface 244 extending radially from the second axial transitional surface 242 to the second outside radial extremity 236, the second upper radial surface 244 being spaced axially away from the second lower radial surface 240 a second predetermined surface 246. The second lower radial surface 240 may define the third axial extremity 232.

The description of the various embodiments focuses on the top or “12 O'clock” portion of the face seal assemblies. Accordingly, the term “upper” may be interpreted to be synonymous with “outer” or “outwardly”, etc. and the term “lower” may be interpreted to be synonymous with “inner” or “inwardly”, etc. Directions such as “axially” or “radially” are to be interpreted to include any direction that is parallel to, or that forms an acute angle with the direction that is less than 45 degrees. “Purely axially” is to be interpreted to cover any direction that is parallel to or that forms an acute angle with an axis that is within +/−5 degrees. Similarly, “purely radially” is to be interpreted to cover any direction that is parallel to or that forms an acute angle with the radial direction that is within +/−5 degrees of the radial direction. When a feature is arcuate, then the acute angle is to be measured using a tangent to the arcuate shape.

As shown in FIGS. 3 and 4, the upper radial surfaces 224, 244 and the lower radial surfaces 220, 240 may be purely radial and the axial transitional surfaces 222, 242 may be purely axial in some embodiments, but not necessarily so. More particularly, the first lower radial surface 220 and the second lower radial surface 240 may be entirely purely radial or may have an arcuate shape that extends at least partially radially. In either case, the first lower radial surface 220 and the second lower radial surface 240 may contact each other and form an inner seal, such as an inner sealing line of contact that is intended to keep lubricant from leaking from the rotating joint. Put another way, the first lower radial surface 220 at least partially contacts the second lower radial surface 240, such as tangentially, to the form the inner sealing line of contact.

As best seen in FIG. 4, the second predetermined distance 246 may be greater than the first predetermined distance 225, forming a gravity pump 248 between the first upper radial surface 224 and the second upper radial surface 244. The “gravity pump” is so called as the weight of debris may cause the debris to exit when this feature is at the bottom or “6 O'clock” position. The first axial transitional surface 222 may be spaced away from the second axial transitional surface 242 forming a radial gap 250. The difference 252 of the second predetermined distance 246 minus the first predetermined distance 225 may range from 5 mm to 30 mm. Also, the radial gap 250 may define a radial dimension 254 ranging from 1 mm to 3 mm.

The first upper radial surface 224 may define an upper radial slot 256 disposed radially adjacent the first outside radial extremity 216 that extends a first axial depth 258. The first upper radial surface 224 may further define a lower radial slot 260 disposed radially adjacent the first axial transitional surface 222 that extends a second axial depth 262. The lower radial slot 260 may be in communication with the upper radial slot 256 and the second axial depth 262 may be greater than the first axial depth 258. This may not be the case in other embodiments.

Furthermore, the first upper radial surface 224 defines a sealing surface 264 disposed in the upper radial slot 256, defining the first axial depth 258. Also, the first upper radial surface 224 may define a ledge 266 that borders the lower radial slot 260. The assembly 200 may further comprise a sealing member 268 extending from the second radial upper surface 244, contacting at least one of the sealing surface 264 and the ledge 266. As shown, the sealing member 268 may contact the sealing surface 264 and not the ledge 266.

In some embodiments, but necessarily every embodiment, the first cylindrical axis 208 is coaxial with the second cylindrical axis 228, the first inside radial extremity 218 is coextensive with the second inside radial extremity 238, and the first outside radial extremity 216 is coextensive with the second outside radial extremity 236.

If debris gets past the sealing member 268 or if the sealing member 268 itself wears, the debris may fall into the lower radial slot 260, which may act as a “debris trap”. Then, as the sealing member 268 wears to the point that it no longer contacts the sealing surface 264, then the sealing member 268 may rest on the ledge 266 due to the fact it is elastically flexed originally to contact the sealing surface 264. This second sealing position of the sealing member 268 may not be present in all embodiments. Even if the sealing member 268 does not contact the ledge 266, once a gap is present between the sealing member 268 and the sealing surface 264, the lower radial slot 260 may act as a “debris sling”, so called as the debris in this slot 260 may be forced radially away from the assembly 200 due to centrifugal force, air pressure, etc. Hence, as alluded to earlier herein, the sealing member 268 and the second face seal member 204 may be attached to a rotating component of the rotating joint. The ledge 266, the upper radial surfaces 224, 244 and the axial transitional surfaces 222, 242 form a serpentine path, making it less likely that debris from the “debris trap” or “debris sling” will infiltrate to the lower radial surfaces 220, 240, causing wear that may result in a loss of lubricant sealing.

Another face seal assembly 300 according to another embodiment of the present disclosure may be characterized as follows with reference to FIGS. 3 and 4. The face seal assembly 300 may comprise a first face seal member 202 including a first cylindrical annular body 206 defining a first cylindrical axis 208, a first radial direction 210, a first axial extremity 212, a second axial extremity 214, a first outside radial extremity 216 and a first inside radial extremity 218. The first face seal member 202 may further comprise a first upper radial surface 224 extending radially from the first outside radial extremity 216, the first upper radial surface 224 defining an upper radial slot 256 disposed radially adjacent the first outside radial extremity 216. The upper radial slot 256 may be at least partially defined by a sealing surface 264. Also, the first upper radial surface 224 may further define a lower radial slot 260 disposed radially below the upper radial slot 256, being in communication therewith and terminating at a depth positioned axially past the sealing surface 264.

The face seal assembly 300 may further comprise a second face seal member 204 including a second cylindrical annular body 226 defining a second cylindrical axis 228, a second radial direction 230, a third axial extremity 232, a fourth axial extremity 234, a second outside radial extremity 236 and a second inside radial extremity 238. A second upper radial surface 244 may extend radially from the second outside radial extremity 236. A sealing member 268 may extend from the second upper radial surface 244 and contacting the sealing surface 264. The first upper radial surface 224 may define a ledge 266 bordering the lower radial slot 260 and the sealing member 268 may define or form a narrow gap 370 with the ledge 266 (see FIG. 4). The minimum dimension of the narrow gap 370 may range from 0.5 mm to 2 mm in some embodiments.

As also best seen in FIG. 4, the second upper radial surface 244 may define a notch 372 configured to receive the sealing member 268. In addition to or in lieu of the notch 372, adhesive or epoxy may be used to attach the sealing member 268 to the second face seal member 204. The sealing member 268 may include a plastic elongated member defining a thickness T ranging from 0.5 mm to 3 mm, and curvilinear length L ranging from 7 mm to 30 mm. The sealing member 268 may comprise PTFE (polytetrafluorethylene) with glass fibers and molybdenum disulfide added to the PTFE, or at least one glass fibers and molybdenum disulfide added to the PTFE.

Looking at FIGS. 3 and 4, the first face seal member 202 may include a first axial transitional surface 222 extending from the first upper radial surface 224, and a first lower radial surface 220 extending radially from the first axial transitional surface 222 to the first inside radial extremity 218. The first upper radial surface 224 may define the first axial extremity 212.

Likewise, the second face seal member 204 may include a second axial transitional surface 242 extending from the second upper radial surface 244. A second lower radial surface 240 may extend radially from the second axial transitional surface 242 to the second inside radial extremity 238. The second lower radial surface 240 defining the third axial extremity 232.

Yet another face seal assembly 400 according to another embodiment of the present disclosure may be characterized as follows with reference to FIGS. 3 and 4. The face seal assembly 400 may comprise a first face seal member 202 including a first cylindrical annular body 206 defining a first cylindrical axis 208, a first radial direction 210, a first axial extremity 212, a second axial extremity 214, a first outside radial extremity 216 and a first inside radial extremity 218. A first upper radial surface 224 may extend radially from the first outside radial extremity 216. The first upper radial surface 224 may define an upper radial slot 256 disposed radially adjacent the first outside radial extremity 216. The upper radial slot 256 being at least partially defined by a sealing surface 264. The first upper radial surface 224 may further define a lower radial slot 260 disposed radially below the upper radial slot 256, being in communication therewith. The lower radial slot 260 may extend axially past the sealing surface 264. The first upper radial surface further defines a ledge 266 disposed radially below the sealing surface 264.

The face seal assembly may further comprise a second face seal member 204 including a second cylindrical annular body 226 defining a second cylindrical axis 226, a second radial direction 230, a third axial extremity 232, a fourth axial extremity 234, a second outside radial extremity 236 and a second inside radial extremity 238. A second upper radial surface 244 may extend radially from the second outside radial extremity 236. A sealing member 268 may extend axially and radially from the second upper radial surface 244 and contact the sealing surface 264.

More specifically, the sealing member 268 may be flexed, extending along a curvilinear length L from the second upper radial surface 244 to the sealing surface 264. The sealing surface 264 may extend purely radially. The curvilinear length L may define a tangent 474 that forms a first acute angle 476 with first radial direction 210 ranging from 20 degrees to 90 degrees.

In like fashion, the lower radial slot 260 defines a lower sloped surface 478 that is positioned axially forward of the sealing surface 264, allowing debris to fall past the sealing surface and to fall to the bottom of the lower radial slot. The lower radial slot 260 defines an axis of extension 480 that forms a second acute angle 482 with the first radial direction 210 that ranges from 20 degrees to 70 degrees.

Any of these dimensions may be varied as needed or desired in other embodiments to be different than what has been specifically mentioned herein.

The arrangement and function of these various components of the face seal assembly, the face seal member, and/or the sealing member may be altered as needed or desired. Furthermore, the material of the face seal members and the sealing member may be made from any suitable material including steel, metal, ceramic, plastic, etc. Likewise, coatings may be applied to the face seal members and the sealing member, etc. In many embodiments, the components and features extend circumferentially in manner consistent with have a constant cross-section in any plane passing through the longitudinal axes but not necessarily so.

### INDUSTRIAL APPLICABILITY

In practice, a rotating joint, a face seal assembly, a face seal member, and/or a sealing member according to any embodiment described herein may be sold, bought, manufactured or otherwise obtained in an OEM or after-market context.

While powertrain and undercarriage applications have been specifically discussed herein, it is contemplated that a face seal member, face seal assembly, etc. according to various embodiments of the present disclosure may be used in other applications. For example, such other applications may include agriculture, petroleum, tunneling, waste handling, forestry construction, military, and waste handling, etc. The seals may be used in various components such as drill heads, pumps, tunnel boring cutters, as well as the aforementioned final drives, axles, and undercarriage platforms.

Various embodiments of the face seal members and face seal assemblies may include specific embodiments such as metal face seals, Duo-Cone seals, floating seals, mechanical face seals, and Heavy Duty Dual Face (HDDF). Thus, the claims and specific properties of one embodiment should not be interpreted to be necessary in all the embodiments contemplated herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A face seal assembly comprising:
a first face seal member including
a first cylindrical annular body defining a first cylindrical axis, a first radial direction, a first axial extremity, a second axial extremity, a first outside radial extremity and a first inside radial extremity;
a first lower radial surface extending radially from the first inside radial extremity;
a first axial transitional surface extending axially from the first lower radial surface; and
a first upper radial surface extending radially from the first axial transitional surface to the first outside radial extremity, the first upper radial surface being spaced axially away from the first lower radial surface a first predetermined distance, defining the first axial extremity;
a second face seal member including
a second cylindrical annular body defining a second cylindrical axis, a second radial direction, a third axial extremity, a fourth axial extremity, a second outside radial extremity and a second inside radial extremity;
a second lower radial surface extending radially from the second inside radial extremity;
a second axial transitional surface extending axially from the second lower radial surface; and
a second upper radial surface extending radially from the second axial transitional surface to the second outside radial extremity, the second upper radial surface being spaced axially away from the second lower radial surface a second predetermined surface, the second lower radial surface defining the third axial extremity.

2. The face seal assembly of claim 1 further comprising a first load ring and a second load ring.

3. The face seal assembly of claim 1 wherein the second predetermined distance is greater than the first predetermined distance, forming a gravity pump between the first upper radial surface and the second upper radial surface, the first lower radial surface at least partially contacts the second lower radial surface, and the first axial transitional surface is spaced away from the second axial transitional surface forming a radial gap.

4. The face seal assembly of claim 3 wherein the difference of the second predetermined distance minus the first predetermined distance ranges from 5 mm to 30 mm, and wherein the radial gap defines a radial dimension ranging from 1 mm to 3 mm.

5. The face seal assembly of claim 3 wherein the first upper radial surface defines an upper radial slot disposed radially adjacent the first outside radial extremity that extends a first axial depth, the first upper radial surface further defining a lower radial slot disposed radially adjacent the first axial transitional surface that extends a second axial depth, wherein the lower radial slot is in communication with the upper radial slot and the second axial depth is greater than the first axial depth.

6. The face seal assembly of claim 5 wherein the first upper radial surface defines a sealing surface disposed in the upper radial slot, defining the first axial depth, the first upper radial surface also defining a ledge that borders the lower radial slot, the assembly further comprising:
a sealing member extending from the second radial upper surface, contacting at least one of the sealing surface and the ledge.

7. The face seal assembly of claim 1 wherein the first cylindrical axis is coaxial with the second cylindrical axis, the first inside radial extremity is coextensive with the second inside radial extremity, and the first outside radial extremity is coextensive with the second outside radial extremity.

8. A face seal assembly comprising:
a first face seal member including
a first cylindrical annular body defining a first cylindrical axis, a first radial direction, a first axial extremity, a second axial extremity, a first outside radial extremity and a first inside radial extremity;
a first upper radial surface extending radially from the first outside radial extremity, the first upper radial surface defining an upper radial slot disposed radially adjacent the first outside radial extremity, the upper radial slot being at least partially defined by a sealing surface;
a second face seal member including
a second cylindrical annular body defining a second cylindrical axis, a second radial direction, a third axial extremity, a fourth axial extremity, a second outside radial extremity and a second inside radial extremity;
a second upper radial surface extending radially from the second outside radial extremity; and
a sealing member extending from the second upper radial surface and contacting the sealing surface.

9. The face seal assembly of claim 8 wherein the first upper radial surface further defines a lower radial slot disposed radially below the upper radial slot, being in communication therewith and terminating at a depth positioned axially past the sealing surface and the first upper radial surface defines a ledge bordering the lower radial slot and the sealing member defines a narrow gap with the ledge.

10. The face seal assembly of claim 8 wherein the second upper radial surface defines a notch configured to receive the sealing member.

11. The face seal assembly of claim 8 wherein the sealing member includes a plastic elongated member defining a thickness ranging from 0.5 mm to 3 mm, and a curvilinear length ranging from 7 mm to 30 mm.

12. The face seal assembly of claim 11 wherein the sealing member comprises PTFE with glass fibers and molybdenum disulfide added to the PTFE.

13. The face seal assembly of claim 8 wherein the first face seal member includes
a first axial transitional surface extending from the first upper radial surface; and
a first lower radial surface extending radially from the first axial transitional surface to the first inside radial extremity, the first upper radial surface defining the first axial extremity.

14. The face seal assembly of claim 13 wherein the second face seal member includes
a second axial transitional surface extending from the second upper radial surface; and
a second lower radial surface extending radially from the second axial transitional surface to the second inside radial extremity, the second lower radial surface defining the third axial extremity.

15. A face seal assembly comprising:
a first face seal member including
a first cylindrical annular body defining a first cylindrical axis, a first radial direction, a first axial extremity, a second axial extremity, a first outside radial extremity and a first inside radial extremity;
a first upper radial surface extending radially from the first outside radial extremity, the first upper radial surface defining an upper radial slot disposed radially adjacent the first outside radial extremity, the upper radial slot being at least partially defined by a sealing surface;
the first upper radial surface further defining a lower radial slot disposed radially below the upper radial slot, being in communication therewith and terminating at a depth positioned axially past the sealing surface, the first upper radial surface further defining a ledge disposed radially below the sealing surface;
a second face seal member including
a second cylindrical annular body defining a second cylindrical axis, a second radial direction, a third axial extremity, a fourth axial extremity, a second outside radial extremity and a second inside radial extremity;
a second upper radial surface extending radially from the second outside radial extremity; and
a sealing member extending axially and radially from the second upper radial surface and contacting the sealing surface.

16. The face seal assembly of claim 15 wherein the sealing member is flexed, extending along a curvilinear length from the second upper radial surface to the sealing surface and the sealing surface extends purely radially.

17. The face seal assembly of claim 16 wherein the curvinlear length defines a tangent that forms a first acute angle with first radial direction ranging from 20 degrees to 90 degrees.

18. The face seal assembly of claim 15 wherein the sealing member comprises PTFE and at least one of glass fibers and molybdenum disulfide.

19. The face seal assembly of claim 15 wherein the sealing member makes a first line of contact with the sealing surface and forms a narrow gap with the ledge.

20. The face seal assembly of claim 15 wherein the lower radial slot defines a lower sloped surface that is positioned axially forward of the sealing surface and the lower radial slot defines an axis of extension that forms a second acute angle with the first radial direction that ranges from 20 degrees to 70 degrees.
